(19) United States
(12) Patent Application Publication
(10) Pub. No.: US 2016/0277851 A1
(43) Pub. Date: Sep. 22, 2016

(54) SOUND CONDUCTOR FOR A HEARING DEVICE, MAIN UNIT OF A HEARING DEVICE AND HEARING DEVICE

(71) Applicant: SIVANTOS PTE. LTD., SINGAPORE (SG)

(72) Inventors: EDUARDO JR BAS, SINGAPORE (SG); HOONG YIH CHAN, SINGAPORE (SG); CHUAN FOONG LEE, JOHOR BAHUR (MY)

(21) Appl. No.: 15/075,419

(22) Filed: Mar. 21, 2016

(30) Foreign Application Priority Data
Mar. 19, 2015 (DE) 102015204997.3

(51) Int. Cl. H04R 25/00; H04R 3/02; H04R 23/00

(52) U.S. Cl. CPC H04R 25/402; H04R 23/002; H04R 3/02; H04R 2225/49

(57) ABSTRACT

A sound conductor for a hearing device, particularly for a hearing aid, includes a housing, at least one sound generator formed by a thermoacoustic transducer, a plurality of signal ports connected to the sound generator, and a securing device for reversible securing to a main unit of the hearing device to produce an electrical connection between at least one signal port and a signal output of the main unit. The housing has a sound channel formed therein to conduct sound generated by the sound generator in a direction of propagation to a sound output of the housing. A corresponding main unit includes a securing device for reversible securing to the sound conductor. A hearing device includes a main unit and a sound conductor being secured to one another by the securing devices.

### CROSS-REFERENCE TO RELATED APPLICATION

This application claims the priority, under 35 U.S.C. §119, of German Patent Application DE 10 2015 204 997.3, filed Mar. 19, 2015; the prior application is herewith incorporated by reference in its entirety.

### BACKGROUND OF THE INVENTION

### Field of the Invention

The invention relates to a sound conductor for a hearing device, particularly for a hearing aid, which includes a housing and a securing device for reversible securing to a main unit of the hearing device, in which the housing has a sound channel formed therein for conducting sound in a direction of propagation to a sound output of the housing. The invention also relates to a main unit of a hearing device and to a hearing device.

In a hearing aid that has a microphone and an electroacoustic transducer, mechanical vibrations brought about by the electroacoustic transducer can lead to instability in the signal path. By way of example, the vibrations can be recorded by the microphone by dint of acoustic feedback and converted into an electrical signal that, following amplification, is supplied to the electroacoustic transducer and converted into sound by the latter. That forms a closed loop in which vibrations can be amplified to an ever greater extent.

Such purely acoustic feedback is usually rejected as far as possible by suitable signal processing, for example by using an adaptive filter, and also by sufficient acoustic shielding. In many hearing aids, however, vibration brought about by the electroacoustic transducer can additionally feed back electromagnetically. The electroacoustic transducer usually has a diaphragm. An electrical input signal is used to produce a time-variant magnetic field that—possibly indirectly through a magnetizable connecting rod—excites the diaphragm to produce oscillations that produce the desired sound signal. Mechanical vibrations in the electroacoustic transducer, which can arise as a result of resonant excitation of the housing surrounding it in the hearing aid, for example, lead to interference in the form of high-frequency signal components in the coils that produce the time-variant magnetic field from the input signal.

Furthermore, many hearing aids have an additional reception coil, which is known as a “telecoil,” through which electromagnetic signals from an external transmitter can be coupled-in directly. External transmitters of that kind are used in museums or churches, for example. A large number of domestic TV sets are also equipped with appropriate transmitters for telecoil reception. The time-variant magnetic field that sets the diaphragm oscillating is then received by the telecoil, as a result of which the latter produces a signal and forwards it to a signal processing unit of the hearing aid. In particular, it is possible in that case for high-frequency signal components brought about by additional mechanical vibration of the electroacoustic transducer in the coils thereof to be coupled-in.

In order to reduce the influence of mechanical vibrations in the electroacoustic transducer on the stability of the signal path, both the occurrence and the transmission of the vibrations can be suppressed by a damping device on the suspension of the electroacoustic transducer—e.g. made of rubber. Similarly, separate shielding, for example by using a shield made of highly permeable metal, can reduce coupling-in of the electromagnetic signal components. That shielding is effective particularly for the high-frequency signal components arising due to the vibration in the electroacoustic transducer.

However, the cited procedure involves respective structural measures that require the configuration of additional assemblies—a mechanical damper or electromagnetic shielding—in the hearing aid. That is often possible only to a very restricted degree, however, for reasons of space. It also increases the weight of the hearing aid, which restricts wearing comfort for a user.

### SUMMARY OF THE INVENTION

It is accordingly an object of the invention to provide a sound conductor for a hearing device, a main unit of a hearing device and a hearing device, which overcome the hereinafore-mentioned disadvantages of the heretofore-known devices of this general type and which reduce vibrations in the hearing device during sound generation as far as possible and prevent electromagnetic feedback as far as possible.

With the foregoing and other objects in view there is provided, in accordance with the invention, a sound conductor for a hearing device, particularly for a hearing aid, comprising a housing, at least one sound generator, a plurality of signal ports connected to the at least one sound generator, and a securing device for reversible securing to a main unit of the hearing device to produce an electrical connection between the signal port or each signal port and a signal output of the main unit, wherein the housing has a sound channel formed therein that is set up to conduct sound generated by the at least one sound generator in a direction of propagation to a sound output of the housing, and wherein the at least one sound generator is formed by a thermoacoustic transducer.

In this case, the sound output may be embodied so as to route a sound signal directly to the ear of a user, or may be set up, by using an appropriate retaining apparatus, in such a way that an ear mold can be fitted on to the sound output through which a sound signal is routed from the sound channel to the ear of the user. By way of example, the securing device can cover a mechanical screw joint or a latching plug connection, with the main unit needing to be equipped with appropriate mating pieces in each case. In the present case, the length of the sound channel can be defined particularly by using the direction of propagation of sound that propagates in the sound channel. The width of the sound channel can accordingly be regarded as a dimension that is locally orthogonal in relation to the direction of propagation. In a variant embodiment that is preferred because it is expedient, the sound channel has a much smaller width compared to its length. In this context, a much smaller width in comparison with the length is intended to be understood to mean particularly a width that is smaller than the length on average at least by a factor of 5, preferably on average at least by a factor of 10.

In this case, the use of a thermoacoustic transducer as a sound generator has the advantage that it does not generate vibration energy during sound generation. A thermoacoustic transducer involves an electrical signal being used to produce a sound signal by virtue of the electrical signal producing temperature fluctuations on a face or a surface of the thermoacoustic transducer. These quickly oscillating temperature fluctuations on the face or surface of the thermoacoustic transducer result in a time-variant temperature gradient in the adjoining air layers. This time-variant temperature gradient can set the adjoining air layers oscillating, with the oscillations propagating as a sound signal.

Such sound generation does not require, and also has no provision for, proper motion, of whatever kind, of the thermoacoustic transducer. The sound generation by the thermoacoustic transducer therefore gives rise to no vibrations that can be output to the surroundings or to a suspension. This is relevant in the case of the sound conductor for a hearing device, particularly against the background that the dimensions that are usually used lead, particularly for the sound channel, to a resonance spectrum that can easily result in instability of the system as a result of mechanical vibration in frequency ranges above 1 kHz. A thermoacoustic transducer, particularly one that is suitable, in terms of its dimensioning, for configuration in a sound conductor, has a particularly dynamic reproduction response for frequencies above 1 kHz.

In this case, the invention exploits the surprising insight that a thermoacoustic transducer disposed in the sound conductor can influence the resonance spectrum of the sound conductor and particularly of the sound channel. Usually, damping elements are used to attempt to optimize the resonance spectrum of the sound conductor for a particularly dynamic reproduction response in relevant frequency ranges, while at the same time the occurrence of mechanical vibrations as a result of a propagating sound signal needs to be prevented as far as possible.

In this context, relevant frequency ranges can usually be regarded as particularly frequencies between 2 kHz and 4 kHz. Good reproduction dynamics, that is to say particularly an output level that is as high as possible in this frequency band, is important specifically for speech intelligibility, since particularly important formats for identifying consonants occur in this frequency band. The resonance spectrum of the sound conductor is thus meant to allow the loudest possible interference-free transmission in this frequency band in order to be able to produce a sound pattern that is as rich as possible during the reproduction of voice. On the other hand, resonances, which can lead to mechanical vibrations, are meant to be prevented as far as possible. In this case, suitable dimensioning and positioning of the thermoacoustic transducer in the sound conductor allows the resonance spectrum to be influenced, so that, firstly, particularly dynamic reproduction is possible in the desired frequency band from 2 kHz to 4 kHz, and, secondly, the damping action of the thermoacoustic transducer in the sound conductor allows undesirable resonance maxima to be damped.

While the use of a thermoacoustic transducer as a sound generator therefore first of all allows substantially vibration-free sound generation, so that no primary vibrations are coupled into the sound conductor, the effect achieved by using the damping action of the thermoacoustic transducer in the sound channel is that propagation of the sound signal, which has been generated by the thermoacoustic transducer itself initially in a manner free of vibration, can largely prevent resonant excitation of the sound conductor to produce vibration.

In accordance with another feature of the invention, preferably, the housing has an acoustic chamber formed in it with a sound passage, wherein the sound channel leads from the sound passage to the sound output of the housing, and wherein the at least one sound generator is disposed in the acoustic chamber.

The dimensions of the sound channel of a sound conductor for a hearing device often allow only little latitude for structural changes, since the dimensions, particularly the width, govern the propagation of the sound through the sound channel and ultimately the resonance spectrum of the sound conductor. This in turn influences what maximum sound pressure level can be transmitted at a respective frequency without undesirable vibration of the sound conductor arising, which could be transmitted to the main unit, and also at what frequencies the maximum gain is possible for a sound signal. Since the dimensions of the sound channel can in most cases only be adjusted slightly, but the sound pressure power of a thermoacoustic transducer may also be dependent on the size thereof, it may be advantageous to place a thermoacoustic transducer for which there is no space in the sound channel in an acoustic chamber that preferably merges into the sound channel.

In accordance with a further feature of the invention, expediently, the thermoacoustic transducer includes at least one film formed from carbon nanotubes that is connected to at least one signal port, wherein application of a signal voltage to the signal port or each signal port brings about time-variant heating in the film or each film, which heating produces a sound by using the thermoacoustic effect. In such a film, the carbon nanotubes may be oriented largely parallel to one another, and even multiple layers of bundles of carbon nanotubes that are parallel to one another, with the orientations of the carbon nanotubes of two successive layers being orthogonal in relation to one another, is possible in this case.

The described microstructure of the film allows largely unhampered propagation of a sound through the film, with a minimal damping action nevertheless remaining, by using which the resonances in the sound channel can be influenced. This firstly allows multiple such thermoacoustic transducers to be disposed parallel to one another without a sound signal generated in a film of a thermoacoustic transducer being adversely affected or even absorbed by an adjacent film of another thermoacoustic transducer. Secondly, this also allows the use of a sound generator in the main unit in such a way that when the sound conductor is secured to the main unit, a sound signal generated in the latter by the sound generator therein can be conducted through a sound input of the sound conductor into the acoustic space and can be conveyed from there to the sound channel without, in so doing, adversely affecting the operation of the thermoacoustic transducer that is disposed in the acoustic space or in the sound channel.

In accordance with an added advantageous feature of the invention, the film of the at least one sound generator is oriented substantially perpendicular to the direction of propagation of a sound, which direction of propagation is prescribed at least to some extent by the sound channel. If the sound generator in this case is disposed not in the sound channel itself but rather in an acoustic chamber that merges into the latter, for example, then determination of the local direction of propagation of the sound in the acoustic chamber requires particularly the use of extrapolation of the direction of propagation in the sound channel into the acoustic chamber. A configuration of the film perpendicular to the direction of propagation can develop a particularly good damping action in respect of the resonance spectrum of the sound conductor, so that this can largely suppress resonance maxima at undesirable frequencies.

In accordance with an additional alternative feature of the invention, the film of the at least one sound generator is oriented substantially longitudinally in relation to the direction of propagation of a sound that is prescribed at least to some extent by the sound channel. In this case, the specific configuration of the film relative to the direction of propagation can be determined particularly on the basis of the effects of the positioning and the orientation of the film on the resonances of the sound conductor.

In accordance with yet another advantage feature of the invention, the housing has a sound input that is acoustically connected to the sound output through the sound channel. In this context, an acoustic connection is intended to be understood to mean a connection that allows controlled, in particular unhampered, propagation of a sound signal. In particular, this includes a connection for flow purposes. In this case, the sound input is preferably set up to conduct a sound generated in the main unit to the sound output through the sound channel while secured to the main unit of the hearing device. In particular, if the dimensions of the sound conductor mean that the thermoacoustic transducer disposed therein achieves sufficient dynamics in reproduction only for higher frequencies, then the sound input can supply a sound signal, generated in the main unit, that has a higher sound pressure, even at lower frequencies, than would be achievable by using the thermoacoustic transducer in the sound conductor to the user. The dynamics that are thus achievable over a large bandwidth allow the sound quality to be improved for the user.

In accordance with yet a further advantage feature of the invention, the sound conductor includes a further sound generator that is formed by a thermoacoustic transducer and that is connected to the signal port or each signal port. A plurality of sound generators that are, in particular, largely of the same construction can generally be used to generate a higher sound pressure than a single sound generator. The use of two or more thermoacoustic transducers for generating sound in the sound conductor is particularly advantageous if the maximum possible dynamic range, that is to say the respective maximum sound pressure, for different frequencies, at which no vibrations in the sound conductor are excited, is not yet exhausted by a single thermoacoustic transducer.

In addition, multiple thermoacoustic transducers that each have a film including carbon nanotubes can be used, by virtue of the damping action thereof, to tune the resonances in the sound channel of the sound conductor in more detail, as a result of which in particular undesirable resonances at unfavorable frequencies, for example at which transmission of vibrations produced to the main unit is possible, can be suppressed particularly effectively.

With the objects of the invention in view, there is also provided a main unit of a hearing device, particularly of a hearing aid, comprising a signal processing unit, a signal output connected to the signal processing unit, and a securing device for reversible securing of a sound conductor as described above to produce an electrical connection between the signal port or each signal port of the sound conductor and the signal output.

In accordance with another feature of the invention, preferably, the main unit in this case has at least one electroacoustic transducer, which is connected to the signal processing unit, and/or at least one microphone that is connected to the signal processing unit. Particularly in combination with an electroacoustic transducer in a main unit, which electroacoustic transducer may be constructed primarily for reproducing low frequencies, the thermoacoustic transducer of the sound conductor, which allows particularly dynamic reproduction above 1 kHz, is advantageous.

With the objects of the invention in view, there is concomitantly provided a hearing device, particularly a hearing aid, comprising a main unit as described above, and a sound conductor as described above, wherein the main unit and the sound conductor are secured to one another through respective securing devices. In this case, the advantages indicated for the sound conductor and developments thereof can be logically transferred to the main unit and the hearing device.

In particular, the hearing device also includes an ear mold that is fitted to the sound output of the sound conductor and that is set up and provided to conduct a sound signal, which is generated in the main unit or in the sound conductor and routed by the sound conductor to the sound output thereof and to the ear of the user of the hearing device.

Other features which are considered as characteristic for the invention are set forth in the appended claims.

Although the invention is illustrated and described herein as embodied in a sound conductor for a hearing device, a main unit of a hearing device and a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, sectional view of a sound conductor for a hearing device having a thermoacoustic transducer in an acoustic space;

FIG. 2 is an enlarged, fragmentary, sectional view of an alternative configuration of the thermoacoustic transducer in the acoustic space of the sound conductor shown in FIG. 1;

FIG. 3 is a view similar to FIG. 2 of an acoustic space of a sound conductor as shown in FIG. 1 with a plurality of thermoacoustic transducers;

FIG. 4 is a sectional view of a main unit of a hearing device; and

FIG. 5 is a side-elevational view of a hearing device having a sound conductor as shown in FIG. 1 and a main unit as shown in FIG. 4.

### DETAILED DESCRIPTION OF THE INVENTION

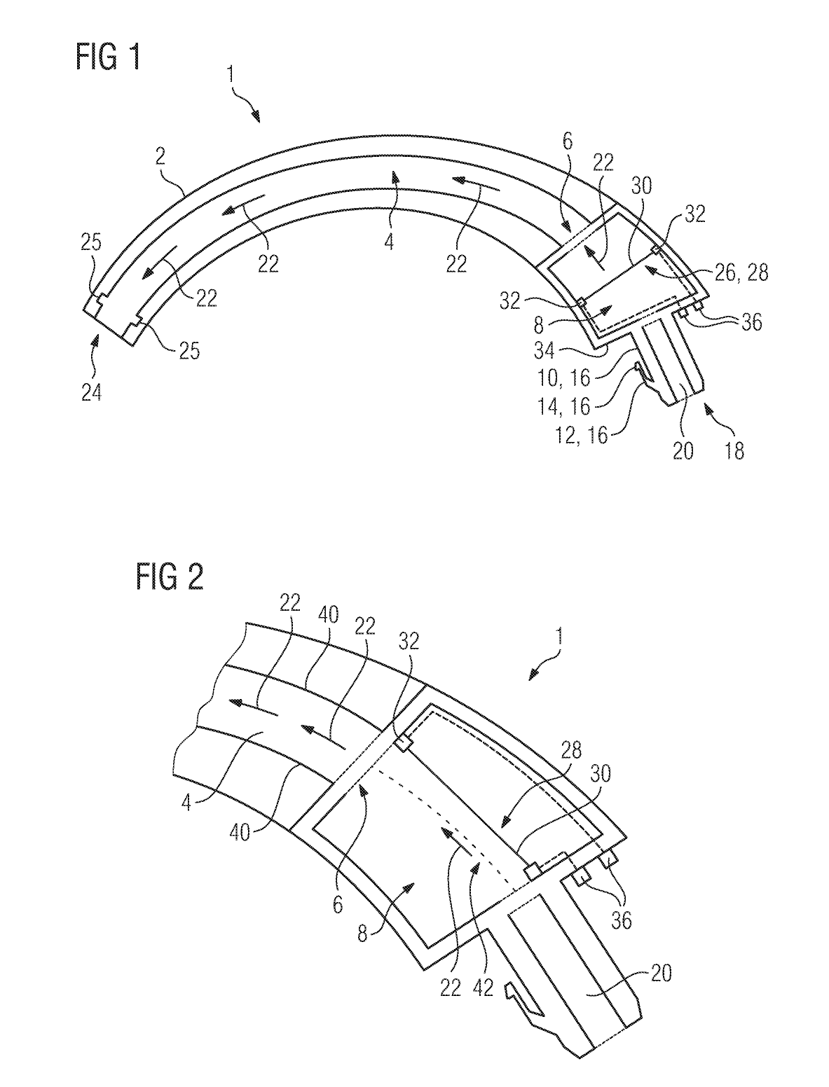

Referring now in detail to the figures of the drawings, in which corresponding parts and magnitudes are provided with the same reference symbols throughout, and first, particularly, to FIG. 1 thereof, there is seen a diagrammatic, sectional illustration of a sound conductor 1 for a hearing device, which is not shown in more detail. The sound conductor 1 includes a housing 2 in which a sound channel 4 and an acoustic chamber 8 are formed. The acoustic chamber 8 is connected to the sound channel 4 by a sound passage 6. One end of the housing 2 has a protruding connecting piece 10, the outer side of which has a spring shackle 12, with a snap-action hook 14 at its end, in the longitudinal direction. The connecting piece 10, the spring shackle 12 and the snap-action hook 14 form a securing device 16 for reversible securing to a non-illustrated main unit of the hearing device.

A free end 18 of the connecting piece 10 has a sound input 20 that leads into the acoustic chamber 8. A sound signal generated in the main unit of the hearing device can therefore be routed through the sound input 20, through the acoustic chamber 8 and through the sound channel 4 in a direction of propagation 22 to a sound output 24 while the sound conductor 1 is secured to the main unit by the securing device 16. A circumferential groove 25 is made in the sound channel 4 at the sound output 24 and can be used to secure an earmold fitted to the sound output.

The acoustic chamber 8 contains a sound generator 26 that is formed by a thermoacoustic transducer 28. In this case, the thermoacoustic transducer 28 has a film 30 including carbon nanotubes that is provided with respective contact points 32 at two opposite edges for the purpose of making contact. In this case, the film 30 is disposed substantially perpendicular to the local direction of propagation 22 of the sound in which a sound signal in the acoustic chamber 8 propagates from the sound input 20 through the sound channel 4 in the direction of the sound output 24.

In the region of the acoustic chamber 8, the housing 2 has a terminal face 34 that supports the connecting piece 10 and that abuts the main unit of the hearing device when secured to the main unit. Besides the connecting piece 10, the terminal face 34 has two signal ports 36 disposed on it that are each connected to a contact point 32. While the sound conductor 1 is secured to the main unit, an electrical signal that is output through an appropriate signal output of the main unit can be supplied to the thermoacoustic transducer 28 through the signal port 36. The signal ports 36 and the contact points 32 respectively connected thereto therefore allow the thermoacoustic transducer 28 to receive an electrical signal from the main unit for conversion into sound while the sound conductor 1 is secured to the main unit.

FIG. 2 shows a fragmentary illustration of an alternative configuration of the thermoacoustic transducer 28 in the acoustic space 8. While the direction of propagation 22 in the sound channel 4 is prescribed by walls 40 thereof, a local direction of propagation 22 can be ascertained in the acoustic chamber 8 by the use of extrapolation 42 of the direction of propagation 22 in the sound channel 4 beyond the sound passage 6 in the direction of the sound input 20. In the present illustration, the film 30 of the thermoacoustic transducer 28 is oriented substantially longitudinally in relation to the local direction of propagation 22 of the sound in the acoustic chamber 8.

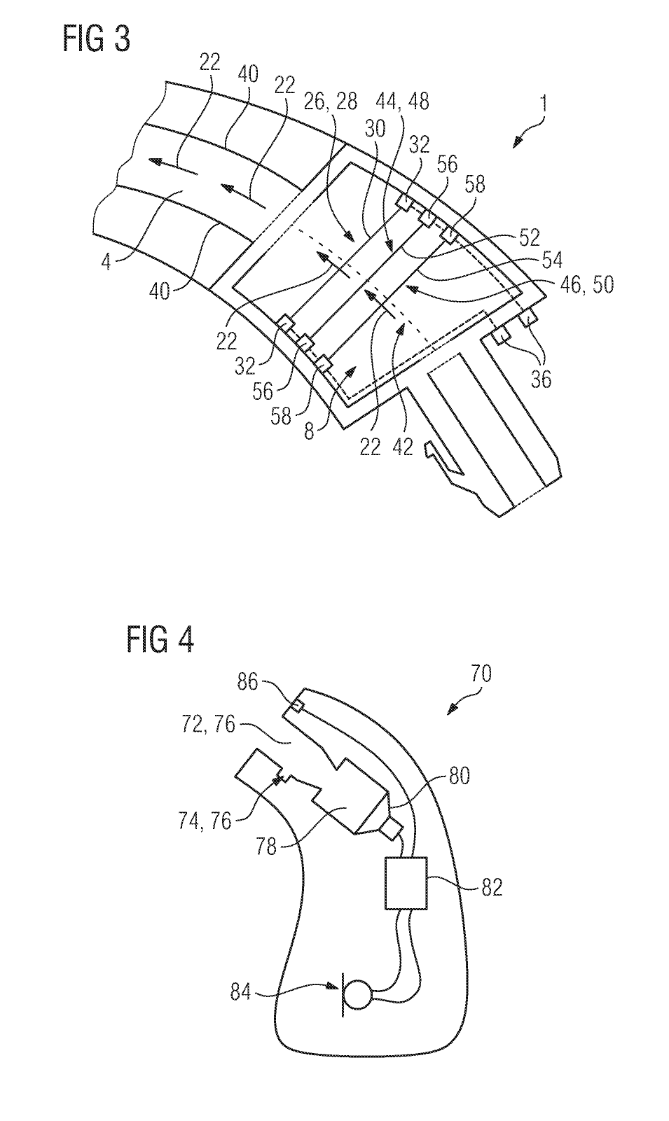

FIG. 3 shows a fragmentary illustration of the acoustic space 8 of the sound conductor 1 shown in FIG. 1, in which the sound conductor contains three sound generators 26, 44, 46 that are each formed by a thermoacoustic transducer 28, 48, 50. In this case, the carbon nanotube films 30, 52, 54 of the thermoacoustic transducers 28, 48, 50 are oriented substantially parallel to one another and are each substantially perpendicular to the local direction of propagation 22. Each of the films 30, 52, 54 has contact points 32, 56, 58, which are each connected to one of the two signal ports 36, at two opposite edges in each case, so that each film 30, 52, 54 is connected to both signal ports 36 in each case. When the sound conductor 1 is in the state of being secured to the main unit, an electrical signal that is supplied to the signal ports 36 through an appropriate signal output of the main unit can be used to actuate the three thermoacoustic transducers 28, 48, 50 simultaneously, so that they convert the electrical signal into sound.

In general, the specific selection of the number of thermoacoustic transducers and the determination of the positioning thereof relative to the sound channel and, if provided in the sound conductor, relative to the acoustic space can be geared to the resonance behavior of the sound conductor. The same is true in the case of carbon nanotube based thermoacoustic transducers for the orientation of the respective film relative to the local direction of propagation of the sound. In this case, a respective damping action that a carbon nanotube film develops as a limiting element of an air column in the sound channel or in the acoustic space needs to be taken into consideration for the resonance spectrum.

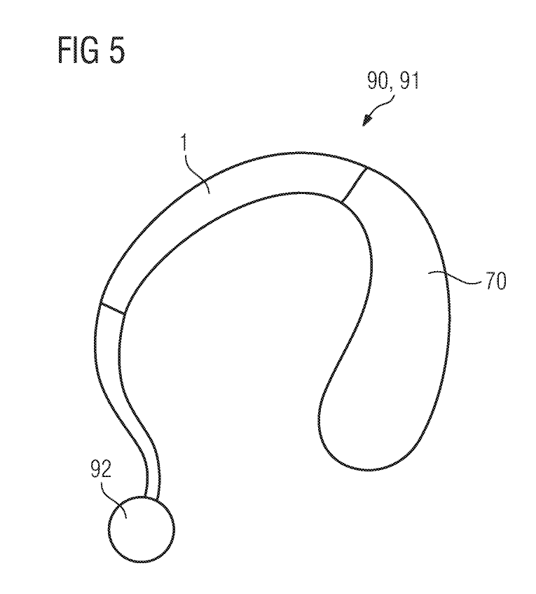

FIG. 4 shows a sectional illustration of a main unit 70 of a hearing device. In this case, the main unit 70 has a receptacle 72 for the connecting piece 10 of a sound conductor 1 as shown in FIG. 1 and a retaining bracket 74 for the latching of the snap-action hook 14. In this case, the receptacle 72 and the retaining bracket 74 form a securing device 76 for reversibly securing the sound conductor 1. The receptacle 72 leads to an acoustic space 78 in the main unit, into which acoustic space an electroacoustic transducer 80 projects. The electroacoustic transducer 80 is connected to a signal processing unit 82 and is set up to convert an electrical signal that is output thereby into sound that propagates primarily into the acoustic space 78 and hence in the direction of the receptacle 72. In this case, the electroacoustic transducer 80 may be in the form of a loudspeaker, for example. The signal processing unit 82 is connected to a microphone 84 that is set up to record sound signals from the surroundings and to convert them into electrical signals that are forwarded to the signal processing unit 82. The signal processing unit 82 is additionally connected to a signal output 86 that is set up to output an electrical signal to the signal ports 36 of the sound conductor 1 when the sound conductor is secured by the securing device 76.

In the sound conductor 1, the electrical signals received thereby at its signal ports 36 are converted into appropriate sound signals by the thermoacoustic transducer(s) 28, 48, 50 disposed in the sound conductor. In particular, the signal processing unit 82 may include a signal switch in this case, so that primarily high-frequency signal components of an electrical signal provided for conversion into a sound signal are output to the signal output 86, while primarily low-frequency signal components for conversion into a sound signal are output to the electroacoustic transducer 80.

FIG. 5 shows a side view of a hearing device 90 having a main unit 70 and a sound conductor 1. In this case, the hearing device 90 is embodied as a hearing aid 91. The sound conductor 1 and the main unit 70 are each secured to one another by a securing device in this case, in the manner in which they are shown in FIG. 1 and FIG. 4. That end of the sound conductor 1 that corresponds to the sound output has an earmold 92 fitted thereon. A sound signal that is generated in the main unit 70 and/or in the sound conductor 1 and is routed by the sound conductor reaches the ear of a user of the hearing aid 91 through the earmold.

Although the invention has been illustrated and described in more detail in terms of the preferred exemplary embodiment, the invention is not restricted by this exemplary embodiment. Other variations can be derived therefrom by a person skilled in the art without departing from the scope of protection of the invention.

1. A sound conductor for a hearing device or hearing aid, the sound conductor comprising:
at least one sound generator formed by a thermoacoustic transducer;
a housing having a sound output, said housing having a sound channel formed therein being constructed to conduct sound generated by said at least one sound generator in a direction of propagation to said sound output;
a plurality of signal ports connected to said at least one sound generator; and
a securing device for reversibly securing the sound conductor to a main unit of the hearing device to produce an electrical connection between at least one of said signal ports and a signal output of the main unit.

2. The sound conductor according to claim 1, wherein said housing has an acoustic chamber formed therein with a sound passage, said sound channel leads from said sound passage to said sound output, and said at least one sound generator is disposed in said acoustic chamber.

3. The sound conductor according to claim 1, wherein said thermoacoustic transducer includes at least one film formed of carbon nanotubes and being connected to at least one of said signal ports, an application of a signal voltage to at least one of said signal ports brings about time-variant heating in said at least one film and said heating produces a sound by using a thermoacoustic effect.

4. The sound conductor according to claim 3, wherein said at least one film of said at least one sound generator is oriented substantially perpendicularly to said direction of propagation of a sound, and said direction of propagation is prescribed at least to some extent by said sound channel.

5. The sound conductor according to claim 3, wherein said at least one film of said at least one sound generator is oriented substantially longitudinally relative to said direction of propagation of a sound, and said direction of propagation is prescribed at least to some extent by said sound channel.

6. The sound conductor according to claim 1, wherein said housing has a sound input being acoustically connected to said sound output by said sound channel.

7. The sound conductor according to claim 1, which further comprises another sound generator being formed by a thermoacoustic transducer and being connected to at least one of said signal ports.

8. A main unit of a hearing device or hearing aid, the main unit comprising:
a signal processing unit;
a signal output connected to said signal processing unit; and
a securing device for reversibly securing the main unit to the sound conductor according to claim 1 to produce an electrical connection between at least one of said signal ports of the sound conductor and said signal output.

9. The main unit of a hearing device according to claim 8, which further comprises at least one electroacoustic transducer connected to said signal processing unit.

10. The main unit of a hearing device according to claim 8, which further comprises at least one microphone connected to said signal processing unit.

11. The main unit of a hearing device according to claim 8, which further comprises at least one electroacoustic transducer connected to said signal processing unit, and at least one microphone connected to said signal processing unit.

12. A hearing device or hearing aid, comprising:
a sound conductor including at least one sound generator formed by a thermoacoustic transducer, a housing having a sound output, said housing having a sound channel formed therein being constructed to conduct sound generated by said at least one sound generator in a direction of propagation to said sound output, a plurality of signal ports connected to said at least one sound generator, and a securing device; and
a main unit including a signal processing unit, a signal output connected to said signal processing unit, and a securing device;
said main unit and said sound conductor being reversibly secured to one another by said respective securing devices to produce an electrical connection between at least one of said signal ports said sound conductor and said signal output of said main unit.
